(19) United States
(12) Patent Application Publication
(10) Pub. No.: US 2006/0176884 A1
(43) Pub. Date: Aug. 10, 2006

(54) Sytems, Methods And Devices For Remotely Administering A Target Device

(75) Inventors: Donald T. Fair, Reston, VA (US); Eric B. Cole, Leesburg, VA (US); Evan M. Teran, Alexandria, VA (US)

Correspondence Address: MARTIN & HENSON, P.C., 9250 W 5TH AVENUE, SUITE 200, LAKEWOOD, CO, 80226, US

(73) Assignee: SYTEX, INC., Doylestown, PA (US)

(21) Appl. No.: 10/906,144

(22) Filed: Feb. 4, 2005

(51) Int. Cl. G06F 15/16; H04Q 7/24; H04L 12/56

(52) U.S. Cl. 370/400; 370/338; 709/203

(57) ABSTRACT

The present invention relates to the manipulation or monitoring of one communications device from another via a network. More particularly, the invention relates to remote control or administration of a target computer from a launch computer via predetermined relay routes therebetween. To this end, systems, devices and methodologies are provided.

### BACKGROUND OF THE INVENTION

The present invention broadly relates to the manipulation or monitoring of one communications device from another via a network. More particularly, the invention relates to remote control or administration of a target computer from a launch computer via predetermined relay routes therebetween. To this end, systems, devices and methodologies are provided.

Since its inception in the 1960's as a packet-switched network, the Internet has grown exponentially into a robust, global network connecting millions of computers. Because the Internet provides fast, inexpensive access to information in revolutionary ways, it has emerged from relative obscurity to international prominence. The Internet itself comprises thousands of interconnected computer networks which are able to share information. These individual networks may be of a variety of types, such as local area networks (LANs) and wide-area networks (WANs), to name a few, and may be categorized by various characteristics including topology, communication protocols and network architecture.

The computers throughout the Internet's infrastructure generate information which is put into packets destined for other computers. The packets can be routed through different computers to arrive at their destination and, over time, various protocols have been designed to allow machines to have guaranteed connections with one another to ensure continued data streams.

The ability to route traffic through one or more network communications devices is not new and it is known to relay traffic along the Internet through dedicated routes, for example, to create a virtual private network(VPN). However, in such situations the identities of the various participants in the relay routing, i.e. the computers themselves, is readily accessible and not concealed.

It is also known to have remote command and control applications with accompanying front-end systems providing a graphical user interface (GUI) for the application. An example of a fully functional front end is NMAP (“Network Mapper”) which is a free open source utility for network exploration or security auditing. In the category of remote administration applications is a program referred to a “Back Orifice” which was once documented on the World Wide Web as a system for allowing a user to control a computer across a TCP/IP connection using a simple console or GUI application. However, the project presently appears to be stagnant in its development and, in any event, not very portable to other operating system platforms. The same holds true for another remote command and control application available written by Carl Fredrik Neikter and referred to as “NetBUS”. Other projects which are known to be available are strictly for Windows machines and fall into the category of remote monitoring but apparently not remote control. These include various computer privacy and Internet security products available from TC-3P online of Winter Springs, Fla. and marketed under the names “eBlaster”, “iSpyNow” and “Net Vizor”.

While the ability to transmit data between computers along predetermined routes and the ability to remotely control a system are prevalent, it is not known by the inventors to combine these capabilities in a manner which obscures or hides the identities of the various participants in order to avoid detection. There are a variety of reasons why one might wish to conceal the identity(ies) of one or more participating computer systems involved in routing data from a source to a destination including, the need for an employer to scrumptiously monitor employee computer activities, or for the purpose of remotely installing and rolling out new applications without any need to alter the base client application. Some of these applications necessarily involve the ability to remotely access and control the target system(s), while others might involve passive monitoring by obtaining feedback from the target system.

### BRIEF SUMMARY OF THE INVENTION

In its various forms, the present invention relates to systems, devices and methods for directing the actions of, or monitoring, one network communications device from another. In preferred embodiments of the invention, the controlling device and the controlled device reside on a network infrastructure, such as the Internet or an intranet, and are adapted to exchange information between them via suitable communication links.

One aspect of the invention provides a system comprising first and second network communications devices and a relay subnet that includes at least one intermediary network communications device, each adapted to communicate according to a layered communications protocol that is characterized by an associated protocol stack, such as the well known TCP/IP stack of protocols. The first network communications device issues a data request to the second network communications device along a predetermined first relay route between them. The second network communications device transmits a reply to the data request along a predetermined second relay route.

The first and second relay routes are defined by a relay subnet which includes the intermediary network communications device. This intermediary is configured to forward outbound traffic corresponding to the data request to the second network communications device without revealing the first network communications device as the origin of the request. Instead, the intermediary device is identified as the origin from the perspective of the second network communications device. The intermediary is also configured to forward inbound traffic corresponding to the reply toward the first device.

The data request from the first device to the second device is preferably transmitted within an outbound relay packet which contains outbound routing information, while the reply is transmitted within a reply relay packet containing return routing information. Advantageously, traffic derived from the data request which arrives at the intermediary device, whether traveling in the outbound direction or the return direction, is forwarded without being passed entirely up the intermediary device's protocol stack. As such, the traffic never reaches upper layers within the stack so that the intermediary device's operating system (OS) can be consider unwitting of the traffic's existence, and presumably its user as well. The second network device is also considered to be unwitting, but is instead unwitting of the true source of the traffic as opposed to its existence.

Command and control system embodiments are also provided. A first exemplary embodiment of such a system comprises a launch computer, a target computer and at least one relay computer. Each of the computers has an associated tool set installed thereon. The launch computer's tool set is configured to issue data requests, while the target computer's tool set is configured to respond to the data requests with data replies. The relay computer's tool set is configured to forward the data requests and replies in the manner discussed above.

Another exemplary embodiment of a command and control system includes launch and target computers, a front end trigger component, a response component and a data transmission component. The front end trigger component issues data requests to the target computer. The data transmission component transmits these requests via a predetermined outbound relay route, while concealing an identity of the launch computer from the target computer. The response component replies to the data requests with data replies and these are transmitted via a predetermined reply relay route by the data transmission component.

The trigger component preferably resides on the launch computer and includes a command and control console, also referred to at times as an administration console, for generating trigger commands corresponding to the data requests. These trigger commands are preferably sent without guaranteeing their delivery, such as through the uniform datagram protocol (UDP). Each of the launch and target computers may include an associated telnet server and a stream server for establishing connections between them and permitting encrypted transmissions. To this end, each computer stores a unique key used for encrypting their transmissions.

The data transmission component comprises an outbound relay subnet including at least one outbound relay computer for forwarding data requests originating from the launch computer toward the target computer, as well as a return relay subnet that includes at least one return relay computer for forwarding data replies originating from the target computer toward the launch computer. The outbound and return relay computer(s) may be the same or different. In a current implementation the return path computers are the same as the outbound computers, but it is contemplated that implementations could be designed where they are different.

Provided also is a network communications device configured for use as a participant in a command and control system, also referred to as an administration system, such as described above. Such a device comprises a memory, a storage device, an I/O system and a processor. The memory stores an operating system (OS) allowing the device to communicate with other computers on a relay network comprising outbound and return relay subnets, while the storage device stores a tool set for issuing data requests to a target computer via the outbound relay network. The I/O system includes a network adapter for interfacing the network communications device to the relay network. The processor is programmed to allow outgoing and inbound packets which are not involved in the relaying system to be processed by the protocol stack without modification. However, with respect to each outgoing packet which corresponds to a data request destined for the target computer, the processor is programmed to incorporate into the outgoing packet associated outbound routing information prior to continued processing by the protocol stack. Further, for those inbound packets which arrive from a relay computer along the return relay subnet, the processor converts them into respective inbound packets corresponding to a reply transmission from the target computer before further processing by the protocol stack.

Finally, a method of remotely accessing and controlling (or simply monitoring) a target computer from a launch computer is also provided. According to the method, system level access to the target computer is obtained. A set of launch tools, such as described above, is installed on the launch computer. A set of target tools are loaded onto the target computer, for example, by uploading them from the launch computer. The target tools include a loadable kernel module (LKM) responsible for retrieving reply data from the target computer in response to a data request from the launch computer. The LKM is installed on the target computer after upload, preferably in a location on the target computer which is unlikely to be accessed by its authorized user. To this end, the location may be somewhere on the hard disk, such as a system file or the like.

After logging off the target computer, an outbound relay packet containing the data request is sent along a predetermined outbound relay route from the launch computer to the target computer. Thereafter, the target computer's reply relay packet is received, with the reply relay packet having traveled along a predetermined return relay route from the target computer to the launch computer.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a component diagram for representing a first exemplary embodiment of a command and control system according to the present invention;

FIG. 2 is a diagrammatic view representing another exemplary embodiment of a command and control system according to the invention;

FIG. 3 is a representative deployment diagram for a command and control system according to the invention, such as the system of FIG. 2;

FIG. 4 is a packaging diagram showing the tools for the launch and target computers;

FIGS. 5a-c illustrate screenshots for a representative graphical user interface (GUI) for the invention's front-end command and control console;

FIG. 6 shows represents a decision-making flowchart when incoming packets are detected by the loadable kernel module (LKM) which resides on the target computer;

FIG. 7 represents a high level flowchart for a methodology which implements the functions of one exemplary embodiment of a remote access and control system according to the invention;

FIG. 8 represents an exemplary network communications device that may be configured to implement aspects of the present invention;

FIG. 9a is a diagrammatic view representing another exemplary embodiment of a remote command and control system;

FIG. 9b is a representative deployment for the command and control system of FIG. 9a;

FIG. 10a is a diagrammatic view representing an exemplary embodiment of a relay system according to the invention;

FIG. 10b is a representative deployment diagram for a relay system of FIG. 10a;

FIG. 11a is a diagrammatic view showing presence of outbound and return relay packets for a representative system incorporating a plurality of relay computers;

FIG. 11b is a diagrammatic view showing presence of outbound and return relay packets for a representative system incorporating a single relay computer;

FIG. 12 is a packet transition diagram showing the various stages assumed by outbound and return relay derived packets within the relay network;

FIG. 13 is a diagrammatic view showing the functional placement of a relay module when installed within an outgoing protocol stack;

FIG. 14a is a diagrammatic representation of a portion of a relay packet's header structure;

FIG. 14b is a diagrammatic representation of an address portion for a relay packet's header structure;

FIG. 15a is a diagrammatic representation showing one approach for encapsulating a relay packet header within a transmission packet;

FIG. 15b is a diagrammatic representation showing another approach for encapsulating a relay packet header within a transmission packet;

FIG. 16a represents a decision-making flowchart on the outgoing protocol stack of the launch computer;

FIG. 16b represents a decision-making flowchart for incoming packets arriving at the launch computer;

FIG. 17 is a diagrammatic view showing the functional interaction of the relay module on the protocol stack of a relay computer which is not a terminal outbound or terminal return relay computer;

FIG. 18 is a decision making flowchart for a terminal outbound or terminal return relay computer;

FIG. 19a is a packet state diagram for outbound and return relay packets as they are transmitted through a relay network having a common pair of outbound and return relay computers, such as shown in FIG. 11a; and

FIG. 19b is a packet state diagram for outbound and return relay packets as they are transmitted through a relay network having a single relay computer, such as shown in FIG. 11b.

### DETAILED DESCRIPTION OF THE INVENTION

The present invention broadly relates to the ability to manipulate or monitor concerns the manipulation or monitoring of one communications device from another, preferably by relaying communications through one or more distinct routes and in a manner which does not reveal all of the actual participants in the communication. Various terms are used throughout the description and the claims which should have conventional meanings to those with a pertinent understanding of computer systems and programming in general, and more particularly network administration. While the description to follow may entail terminology which is perhaps tailored to certain operating system platforms or programming environments, the ordinarily skilled artisan will appreciate that such terminology is employed in a descriptive sense and not for limiting the invention.

In preferred embodiments of the invention, a launch computer system remotely accesses a target through predetermined relay routes along a network infrastructure, such as the Internet and the nodes and the target system are kept unwitting of their role in the communications through the use of loadable kernel modules which obscured or hide relay information. As will be described, since the kernel modules pull packets from the normal TCP stack as they enter the systems, sniffers running on that machines do not receive the packets, nor do they see the packets that are exiting the system. This allows the relay capability to be hidden from the vary computer participants. These capabilities may be desirable, for example, for administrators and employers desiring to monitor computer-related activities of others, or for the remote installation and roll out of new applications, to name only a few possible applications.

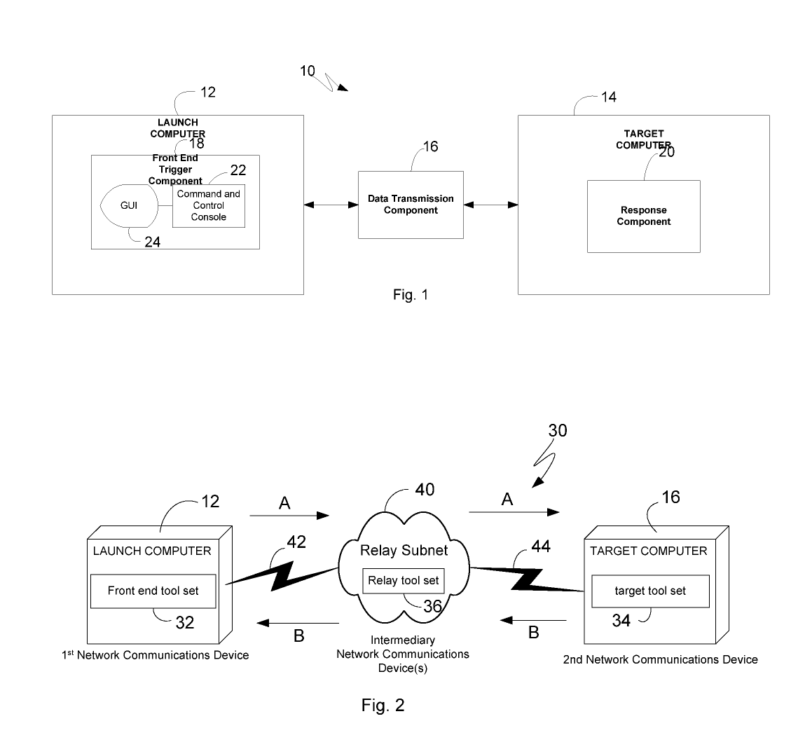

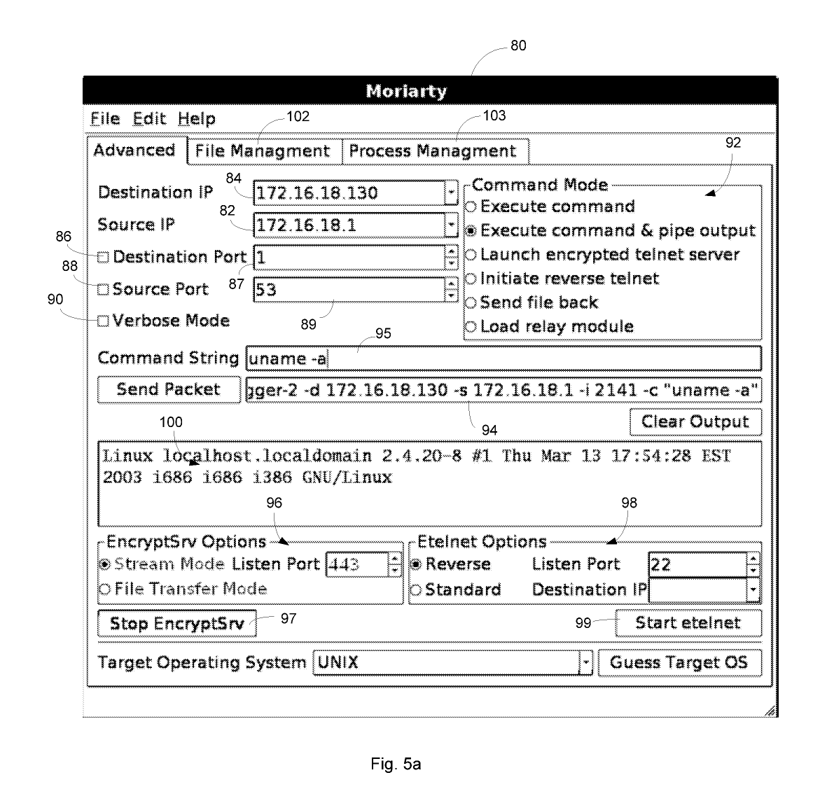

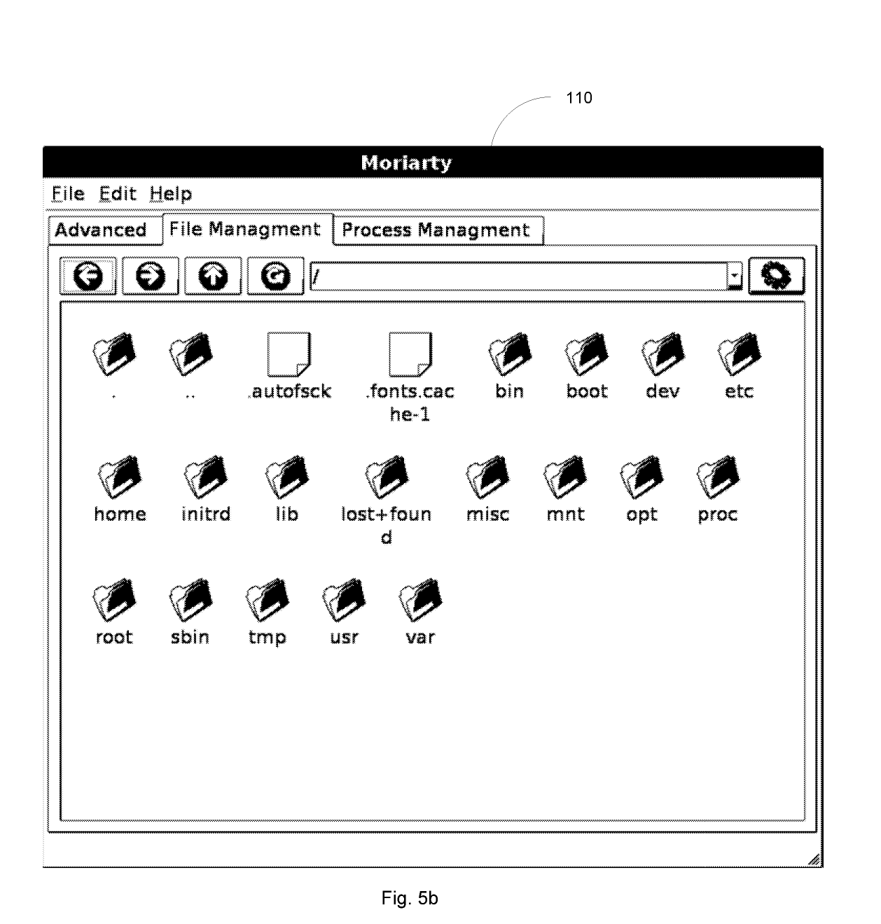

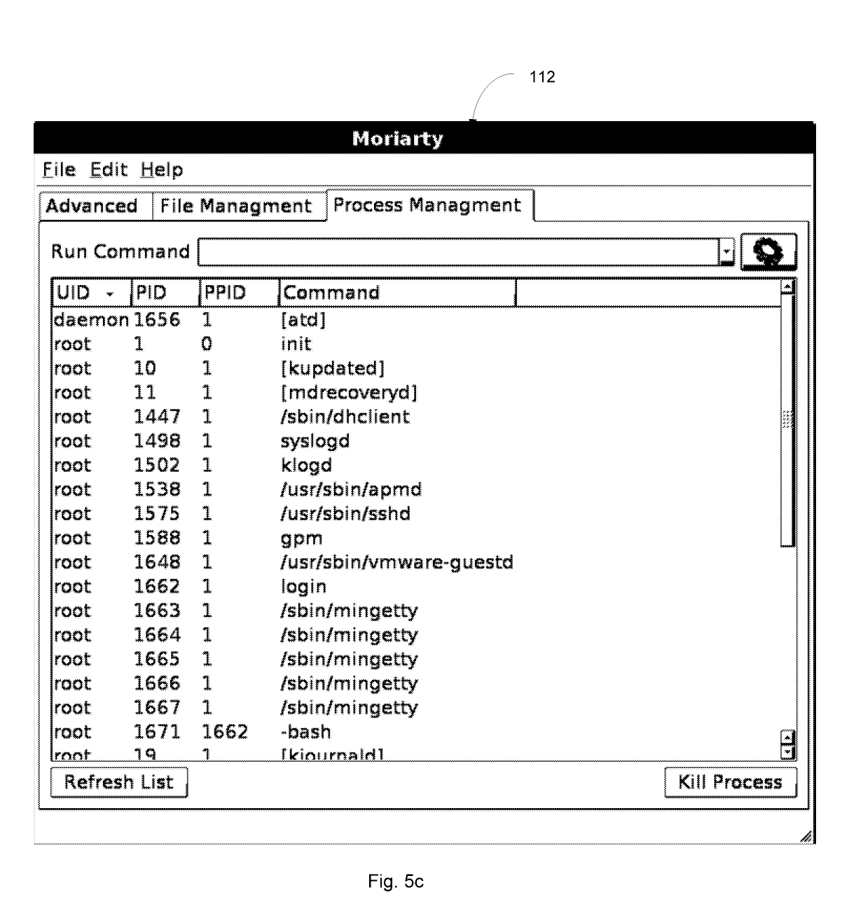

Various embodiments are provided pertaining to the control of one device from another via a network therebetween. In this regard, systems, devices and methodologies are described. Various components for a first exemplary embodiment of a command and control system 10 are shown in FIG. 1. Command and control system 10 includes a first network communications device (1^{st} NCD) 12 in the form of a launch computer and a second network communications (2^{nd} NCD) 14, each of which is preferably adapted to communicate according to a layered communications protocol. A data transmission component 16 functions as an interface between launch computer 12 and target computer 14. A front end trigger component 18 issues data request to the target computer 14 via transmission component 16. A response component 20 associated with target computer 14 replies to the issued data requests with data replies. Advantageously, the front end trigger component 18 resides on launch computer 12 and preferably includes a command and control console 22 for generating trigger commands corresponding to the data requests, as well as a graphical user interface (GUI) 24, illustrated below in FIGS. 5a-5c, for conveniently interacting with a user. The requests for data which are issued by the launch computer's trigger component can relate to any suitable data which resides on the target computer, such as files, directories, network status information, etc., which one might be interested in. In this context, data requests encompass those items of information about the target computer which a user of the launch computer identifies via the front end trigger component 18, and not the type of data which is typically exchanged when two network devices establish connections with one another, unless of course, specifically requested by the user through the trigger component.

FIG. 2 represents another exemplary embodiment of a system 30 according to the invention. Here, system 30 includes the first and second network devices, i.e. launch computer 12 and target computer 14, respectively, and a relay subnet 40. In system 30, 1^{st} NCD 12 issues its data request to 2^{nd} NCD 16 along a predetermined first relay route defined by relay subnet 40, while 2^{nd} NCD 16 replies along a predetermined second relay route also defined by the relay subnet 40. The relay subnet 40 may include one or more intermediary NCDs and is configured to forward outbound traffic (arrows “A”) corresponding to the data request to 2^{nd} NCD 16 in a manner which does not reveal 1^{st} NCD 12 as the origin of the data request, as will be described in more detail below. Reply traffic (return arrows “B”) from 2^{nd} NCD 16 toward 1^{st} NCD 12 also passes through relay subnet 40 which serves to forward the reply.

To accomplish the functionalities for system 30, each participant component preferably has an associated tool set installed thereon. More particularly, launch computer 12 has an associated front end tool set 32, target computer 16 has an associated target tool set 34, while each intermediary computer within the relay subnet 40 preferably has its own relay tool set 36. In this context, the term “tool set” relates to the various software components which reside on the systems in order to accomplish the functionalities described herein, whether the components be modules, files, servers, etc. Accordingly, the terms “tool set” and “tools” should be construed as broadly as possible within the spirit of the invention.

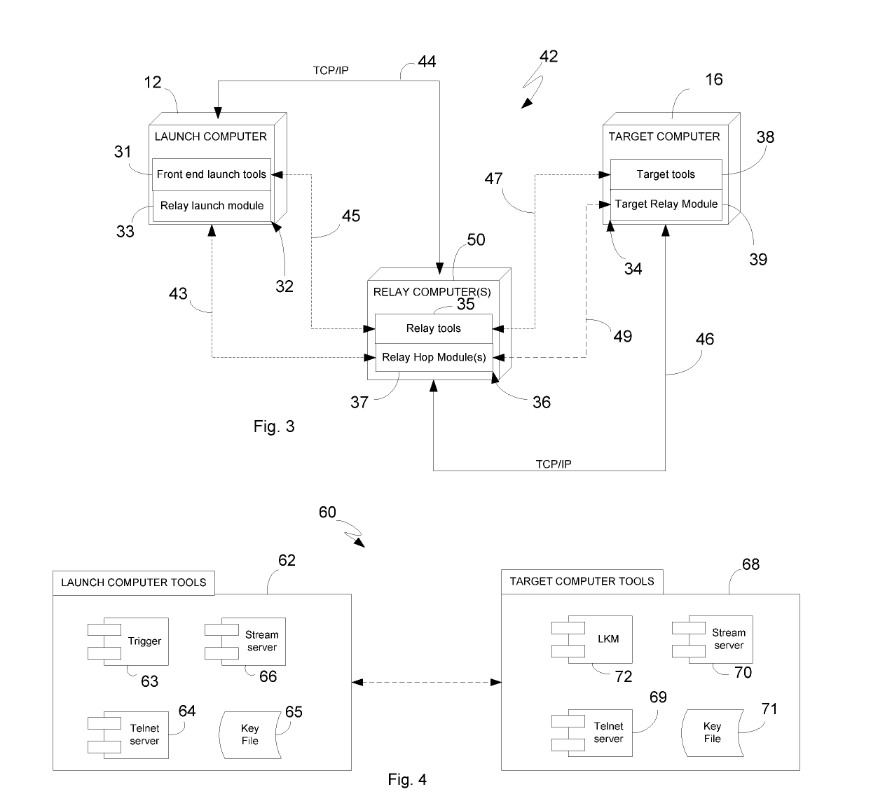

A deployment diagram 42 for the system 30 of FIG. 2 is shown in FIG. 3. Here, it may be seen that launch computer 12, relay computer(s), generally 50, and the target computer 16 communicate over communication links 44 and 46, preferably in accordance with the TCP/IP suite of protocols as well known in the art. The communication links 44 and 46 can be any suitable type(s) and configuration(s) in relation to the hardware, software, protocols and access methods applied in the design of the network architectures, without limitation.

The front end tool set 32 for launch computer 12 includes front end launch tools 31 and a relay launch module 33. Each relay tool set 36 for the various relay computer(s) 50 includes associated relay tools 35 and a relay hop module 37. The target tool set 34 includes target tools 38 and an optional target relay module 39. The logical interactions among the various software components are shown by dotted lines 43, 45, 47 and 49 in FIG. 3. Thus, those software components or tools pertaining to the remote access and control of the target computer 16 from the launch computer 12 logically interact with one another, while those components for accomplishing outbound and return transmissions relating to data requests and the replies logically relate to one another but can exist and function independently. That is, the ordinarily skilled artisan will appreciate from the description herein that one aspect of the invention relates to the remote command and control of a target computer through transmissions which travel along predetermined routes (i.e. relays), while other aspects pertain to the ability to independently control a target computer without regard to transmission routes, and the ability to effectuate transmissions between computers along predetermined relay routes without regard to the purpose behind the communication. These aspects are thus described both collectively and independently herein.

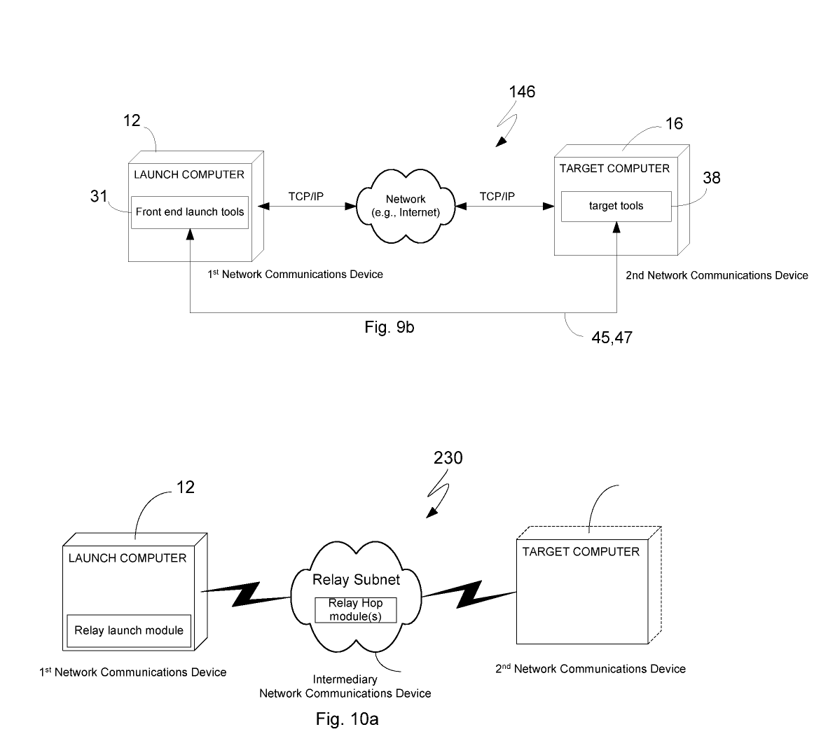

Thus, with brief reference to FIGS. 9a and 9b it may be seen that a dedicated, remote command and control system 130 is contemplated for use with 1^{st} and 2^{nd} NCDs, namely the launch computer 12 and target computer 16 which communicate via a data distribution network 140, such as the Internet. A deployment diagram 146 for such a system 130 is shown in FIG. 9b whereby the computers preferably communicate via TCP/IP and their software components 31 and 38 logically interact as indicated by 45, 47.

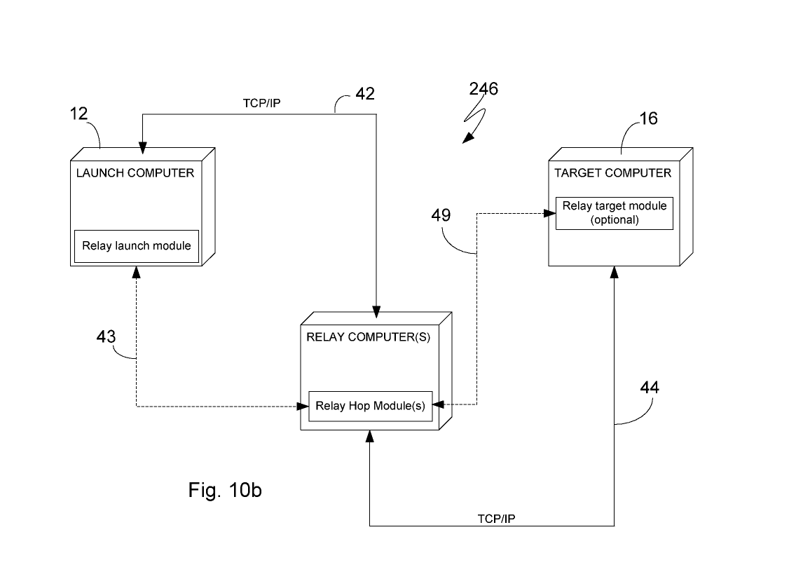

Similarly, as shown in FIGS. 10a and 10b, a dedicated relay system 230 is contemplated wherein launch computer 12 and target computer 16 communicate via a relay subnet 240 whereby outbound packets destined for the target computer 16 are sent along a predetermined first relay route and reply packets originating from target computer 16 are transmitted along a predetermined second relay route. A representative deployment diagram 246 for such a system 230 is shown in FIG. 10b which represents the communications links 42 and 44, as well as the logical software interactions 43 and 49.

Reference is now made to FIG. 4 which shows a packaging diagram 60 for the various software tools within the launch and target computers as they relate to the command and control capabilities. It is to be understood that the corresponding tools for each relay computer used would be similar to those of the target and, hence, are not depicted. The tool package 62 for the launch computer shows that the front end launch tools include a trigger 63, a telnet server 64, a stream server 65 and a key file 66. The tools package 68 associated with the target computer also has an associated telnet server 69, stream server 70 and key file 71. In addition, the target tools include an associated loadable kernel module (LKM).

The trigger 63 for launch package 62 may be in the form of a trigger packet program (e.g. a software module) operative during operation to issue the data requests in the form of trigger commands, as mentioned above with reference to the front end trigger component 18. In use, a front end for a command line-based, remote command and control system is thus provided whereby an operator can execute many commands with system level access on the target computer provided system level access has been obtained through some means. Thus, the application on the launch computer, as diagrammatically represented by the package components 63-65, is capable of executing any command on the remote system (i.e. target computer) that a normal user could execute. The system scripts complex commands to provide a “virtual desktop” giving seamless and user friendly control (via the GUI) to the operator. With the trigger 63 a user can request that the remote LKM 72 reply to a variety of data requests based on various flags. The telnet servers 64 and 69 are provided for establishing connections between the launch and target computers and, in a present implementation, the trigger commands are transmitted to the target computer according to the user datagram protocol (UDP). On the target side, the telnet like server is more or less a standard telnet server with multiple logins and non-essential functionality stripped out. Replies from the target computer may be piped back through encrypted streams by the streams servers 65 and 70 which transmit either files or ASCII streams. In essence, the stream server 70 on the target takes the output of whatever request the launch has asked the LKM 72 to fulfill, and sends it through an encrypted TCP stream back to the launch. Stream server 70 reads the key file 71 and then performs the encryption. It preferably uses standard sockets to open up the TCP stream back to the launch system and send the encrypted data.

The open SSL algorithm, or other suitable approach, may be used to create a public key/private key pair for use during encrypted exchanges. To this end, the target computer will create a session key, encrypt it with the public key and send it to the launch computer. The launch computer then decrypts it with the private key in order to recover the session key, which is particular for that session. Respective key files 66 and 71 reside on the launch and target computers. The key file on the launch side is private and stays on the launch computer, while the key file on the target side is public. Each of these key files stores a common unique key which is used during the initial negotiation to transfer the session key. Thus, each time a new session is established, the session key is encrypted with the same unique key (i.e. the public key) and sent back to the launch system. Necessarily, then, the key file 66 associated with the launch computer system also includes a private key in addition to the unique public key which resides on each system. Of course, the ordinarily skilled artisan will appreciate that a variety of encryption schemes could be employed in order to have encrypted transmissions, for example, synchronous or asynchronous key exchanges coupled with any of a variety of suitable encryption algorithms. Moreover, using encrypted transmissions between the launch and target computers is not a requirement but a preference. It is also preferred to have the encrypted transmissions be in accordance with the transmission control protocol (TCP) and more broadly under the umbrella of IP traffic.

Reference is now made to FIGS. 5a-c which show various screen shots for a representative GUI for the front end command line trigger tool, and representative data is shown in each of the screen shots for purpose of explanation. With initial reference to the screen shot 80 of FIG. 5a, various data input fields may be provided as drop down list boxes to indicate at 82 the source IP address (i.e. the launch computer) from which the data request will be transmitted, and at 84 the destination IP address (i.e. the target computer) from which the request will be fulfilled. Check boxes 86 and 88, respectively, are provided to indicate desired destination and source ports for the trigger request, which are then identified within boxes 87 and 89, respectively. Another check box 90 is provided to indicate whether verbose mode is desired, which causes the entire trigger command to be presented to the user, as opposed to an abbreviated representation.

A group of command mode radio buttons, generally 92, are provided from which the operator of the launch computer selects various operational modes. The first two command modes shown will execute the command provided in field 94 and, optionally, pipe it out to the target computer. A command string field 95 is provided from which the operator can input additional flags, as desired. A radio button is also provided for launching the encrypted telnet server, whose port number may be input into field 95. Similarly, if desired, reverse telnet capability is available by selecting the next radio button down. A radio button is also provided for sending a file back from the target computer, and the file may be designated in field 95. Finally, a radio button is provided to indicate the action of loading the relay module onto the target computer or one of the relay computers, as needed.

Various encryption options are provided generally at 96 to indicate the selected mode and ports for encryption, which is initiated upon activating button 97. If the user selects stream mode then results of the command, as they would otherwise be seen on the target computer, are piped back and displayed in window 100. In file transfer mode, the results are saved in a file. Telnet options are also provided generally at 98 and are initiated upon activating button 99. Selection of the “file management” tab 102 and the “process management” tab 103 brings up windows 110 and 112 shown in FIGS. 5b and c, respectively. Window 110 is populated with a file listing for the target computer, as determined by the destination IP identified in field 84 of FIG. 5a, and this file listing can be navigated through conventional means. Similarly, window 112 is populated with a listing of running processes on the target computer.

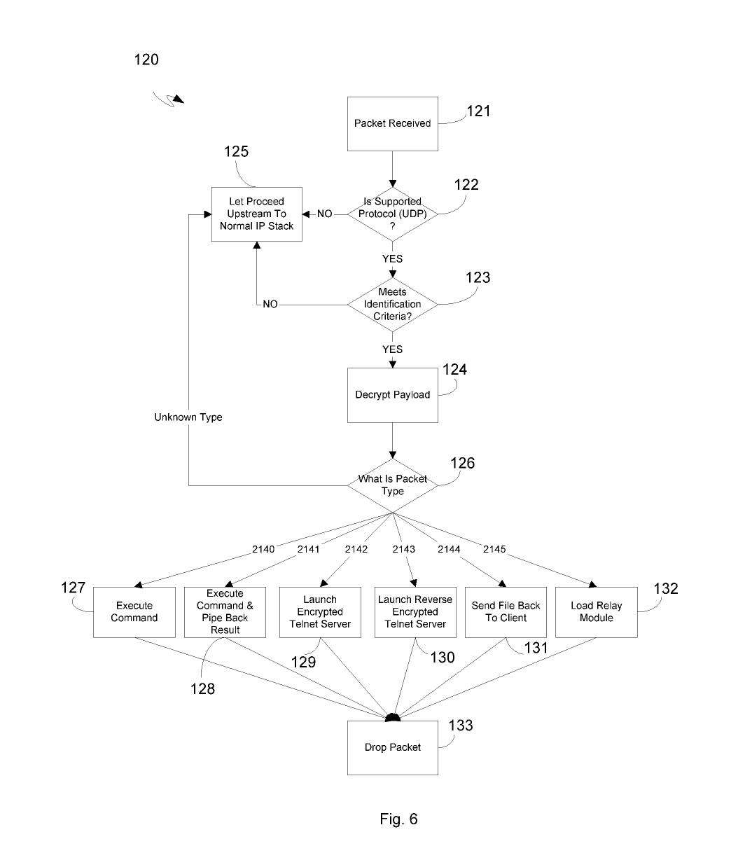

A flow diagram 120 is shown in FIG. 6 to illustrate the decision-making that takes place when incoming packets are detected by the loadable kernel module (LKM) residing on the target computer. When a packet is received at 121, a determination is made at 122 as to whether the packet's supported protocol is UDP. If the packet additionally meets the identification criteria at 123, such as having the unique relay protocol number “5”, then its payload is decrypted at 124. If the received packet is not supported by UDP or its other identification criteria is not met, then it is allowed to proceed upstream to the normal IP stack at 125. Otherwise, once the packet's payload is decrypted at 124, a determination is made at 126 as to what type of packet it is. That is, the LKM determines what type of request is being made by the launch computer, each of which is indicated by boxes 127-132. Each type of request has an associated numerical designator which corresponds to that which populates screen shot 80 in FIG. 5a based on the user's selections at the launch computer. The LKM will then drop the packet at 133 once the request has been satisfied.

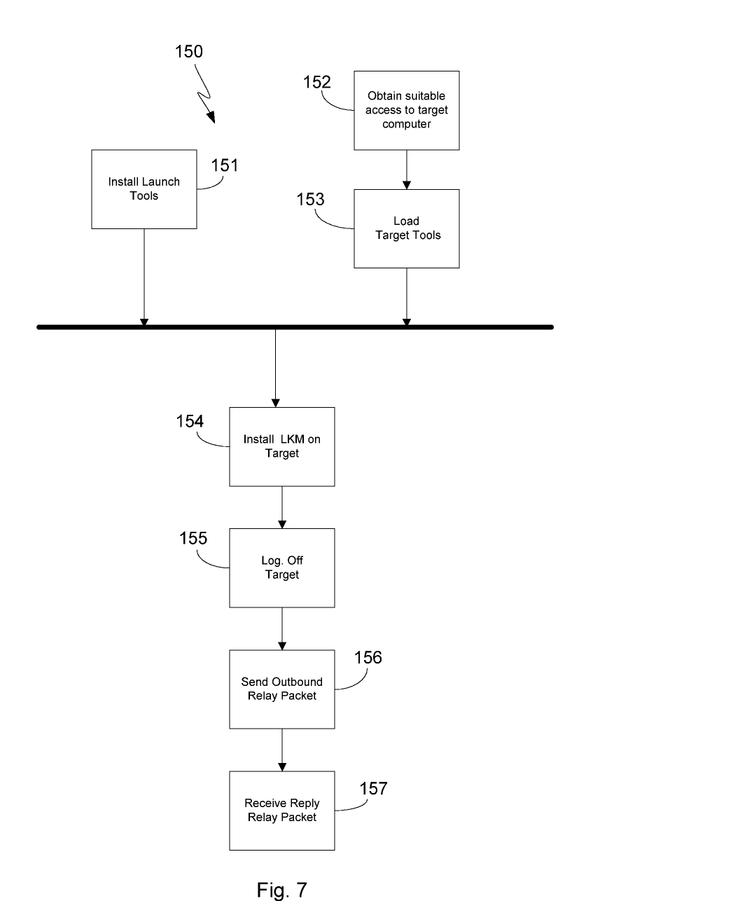

With an appreciation of the above description pertaining to the command and control capabilities, a method 150 (FIG. 7) may be practiced for remotely accessing and controlling a target computer from a launch computer. According to method 150, a set of launch tools is installed at 151 on the launch computer. System level access is obtained for the target computer at 154 since, for purposes of the description, it is assumed that one has administrative rights (i.e. root level access) on the target machine by some means. In any event, once system level access is obtained, a set of target tools is loaded on the target computer at 153, such as by uploading them or otherwise. The target tools preferably include the LKM responsible for retrieving reply data from the target computer in response to a data request issued from the launch computer. Operation 153 might correspond, for example, to the selection of the radio button discussed above in FIG. 5a. It is preferred that the set of target tools be uploaded as compiled programs to a directory within the file system on the target computer's hard disk which is either hidden, such as by a rootkit, or any other suitable location where the authorized user of the target computer would not normally write to or otherwise access. To this end, if the target computer is a Linux or any Unix-like machine, the /dev directory might be appropriate.

At 154 the LKM is installed on the target computer. After logging off at 155, an outbound relay packet is sent at 156 which contains the data request. The outbound relay packet is preferably sent along a predetermined outbound relay route from the launch computer to the target computer. At 157, a reply relay packet is received from the target computer in response to the outbound transmission packet. This reply relay packet is preferably one which traveled along a predetermined return relay route from the target computer to the launch computer.

The purpose of the set of target tools which are uploaded is to allow an operator to reconnect to the target without having to regain system level access or otherwise compromise the machine. Thus, the target tools provide, in part, a sustainable back door (i.e. re-entry) into the target machine. The LKM which is installed is installed via known approaches, such as with the insmod function on Linux machines, and scripts are preferably employed to ensure that it gets reloaded each time the target system is shut down and restarted. As with the other tools, if desired, they can all be hidden by a suitable rootkit in an effort to avoid inadvertent or intentional tampering.

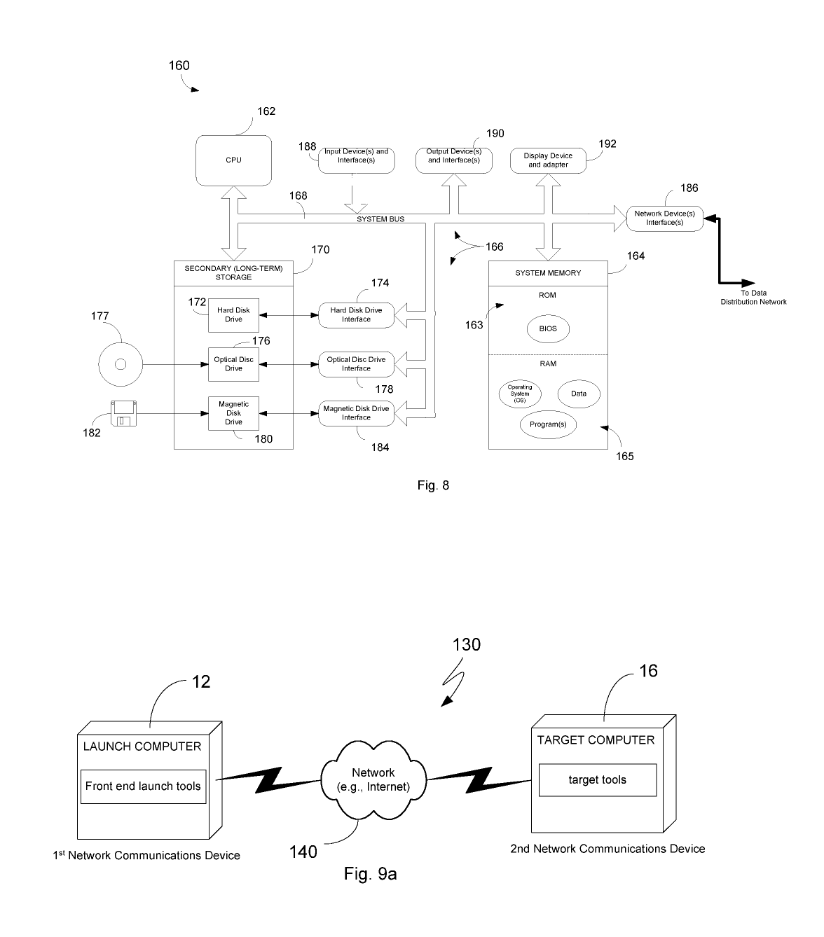

Each network communications device involved in the system of the invention is considered to be a participant which may be configured as a general purpose computer system 160 such as representatively depicted in FIG. 8. System 160 includes a processing unit, such as CPU 162, a system memory 164 and an input output (I/O) system, generally 166. These various components are interconnected by system bus 168 which may be any of a variety of bus architectures. System memory 164 may include both non-volatile read only memory (ROM) 163 and volatile memory such as static or dynamic random access memory (RAM) 165. Programmable read only memories (PROMs), erasable programmable read only memories (EPROMs) or electronically erasable programmable read only memories (EEPROMs) may be provided. ROM portion 163 stores a basic input/output system (BIOS) as shown. RAM portion 165 can store the OS (preferably having the necessary LKMs and network stacks), data, and/or programs such as the trigger console, the telnet server and the stream server. Computer system 160 may be adapted to execute in any of the well-known operating system environments, such as Windows, UNIX, MAC-OS, OS2, PC-DOS, DOS, etc.

Various types of storage devices can be provided as more permanent data storage areas which can be either read from or written to, such as contemplated by secondary storage region 1 70. Such devices may, for example, include a permanent storage device in the form of a large-capacity hard disk drive 1 72 which is connected to the system bus 168 by a hard disk drive interface 174. An optical disk drive 176 for use with a removable optical disk 177 such as a CD-ROM, DVD-ROM or other optical media, may also be provided and interfaced to system bus 168 by an associated optical disk drive interface 178. Computer system 160 may also have one or more magnetic disk drives 180 for receiving removable storage such as a floppy disk or other magnetic media 182 which itself is connected to system bus 168 via magnetic disk drive interface 184. Remote storage over a network is also contemplated.

System 160 may be adapted to communicate with a data distribution network (e.g., LAN, WAN, the Internet, etc.) via communication link(s). Establishing the network communication is aided by one or more network device(s) interface(s) 186, such as a network interface card (NIC), a modem or the like which is suitably adapted for connection to the system bus 168. System 160 preferably also operates with various input and output devices as part of I/O system 166. For example, user commands or other input data may be provided by any of a variety of known types of input device and associated system bus interfaces, generally 188. One or more output devices with associated system bus interfaces, generally 190, may also be provided. A monitor or other suitable display device and its suitable adapter, generally 192, may also be connected to the system bus 168.

One or more of the memory or storage regions mentioned above may comprise suitable media for storing programming code, data structures, computer-readable instructions or other data types for the computer system 160. Such information is then executable by processor 162 so that the computer system 160 can be configured to embody aspects of the present invention. Alternatively, the software may be distributed over an appropriate communications interface so that it can be installed on the user's computer system.

Although certain aspects for the various participant computer system may be preferred in the illustrative embodiments, the present invention should not be unduly limited as to the type of computers on which it runs, and it should be readily understood that the present invention indeed contemplates use in conjunction with any appropriate network communications device having the capability of being configured in a manner for accommodating the invention. Moreover, it should be recognized that the invention could be adapted for use on computers other than general purpose computers, as well as on general purpose computers without conventional operating systems.

As concerns the command and control portion of the invention, an implementation has been designed and coded with python and XML such that it may be portable by nature to any platform supporting the client machine (currently Solaris, FreeBSD, Linux and Windows). It is also compilable on many POSIX compliant systems. The interface has been defined in XML, as defined by the glade-2 specification. Glade-2 is a GUI builder which is based on the Gimp tool kit that is currently available via the web address http://glade.gnome.org/. This is a rapid development tool which allows for quick and easy modification of the actual interface. The actual python program loads this XML at runtime and performs tasks based on input from the operator. It executes all commands through running a new instance of the base client program and capturing its “standard out” and “standard error” through which feedback is provided to the operator. It may also execute many commands before giving feedback to provide a single operation experience for the user when appropriate.

Presently, the system is designed to be as non-overt as possible. It uses minimal Internet traffic to provide its services and all communications are encoded when appropriate to ensure a reasonable level of security. To this end, as few packets as possible are sent and received between the participants, reducing the chance of packet capture or reverse engineering. Presently, encryption is accomplished through the blowfish protocol which has the appeal of not requiring any additional space for the encryption and, as mentioned above, the encryption is dependant on both the target and launch sharing a common encryption/decryption key (the unique key) which is defined at compile time. A key exchange encryption system, though, could be alternatively employed. Also contemplated is the ability to extend the functionality of the front end by making it more automated through the use of options capable of assembling the equivalent of many commands for execution through apparent atomic operation to the user. For example, contemplated is a graphical file transfer mode to allow drag and drop file transfers.

The development tools mentioned above are the preferred tools utilized by the inventors but should not be interpreted to limit the environment of the present invention. Software embodying the various software components described, for example in FIG. 3, may be distributed in known manners which are suitable, such as on computer-readable media containing the executable instructions for performing the methodologies discussed. Alternatively, the software may be distributed over an appropriate communications interface to be installed on the various computer systems.

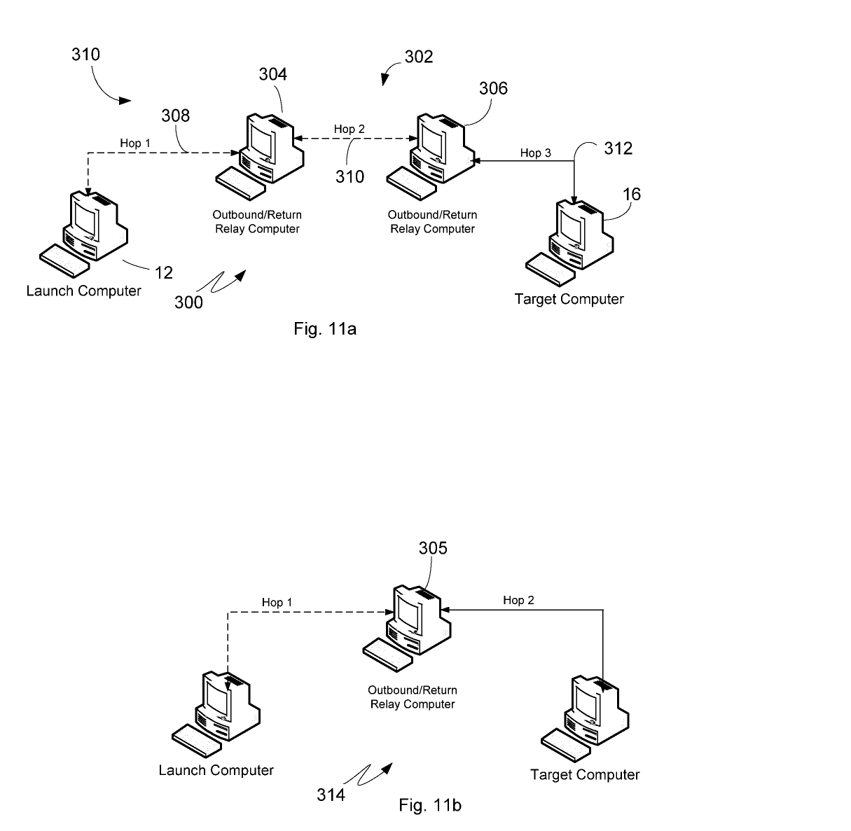

The relay portion of the present invention will now be described with reference to the remaining figures. Initial reference in this regard is made to the diagrammatic views of FIGS. 11a and 11b which illustrate two possible configurations for a relay system and the presence of relay packets used therein. In the relay system 300 of FIG. 11a, a relay subnet 302 is provided which incorporates two relay computers 304 and 306 for both the outbound and return relay packets. Thus, relay hops 308, 310 and 312 are defined between the various participating computer systems. A relay network can, thus, be considered to include the relay subnet and the launch computer 12, and optionally the target computer 16 as well. Data requests issued by launch computer 12 are sent to the target computer 16 along a predetermined first relay route such that they travel from left to right in FIG. 11a through relay computers 304 and 306. Reply packets from target computer 16 toward the launch computer 12 travel from right to left in FIG. 11a along a predetermined second relay route, such that they pass through relay computer 306 and then relay computer 304 before reaching launch computer 12. As such, the diagram in FIG. 11a represents a situation where the relay computers for the outbound relay subnet are the same as those for the return relay subnet, although the ordinarily skilled artisan will readily appreciate that this does not have to be the case and that systems can be designed with one or more computers for both the outbound and return relay subnets, with even some overlap therebetween.

In any event, in the representative diagrammatic view of FIG. 11a, relay computer 304 can be regarded as both an initial outbound relay computer for purposes of outbound traffic from the launch to the target, and a terminal return relay computer for purposes of reply communications from the target toward the launch. Similarly, relay computer 306 can be regarded as a terminal computer for purposes of outbound relay packets and an initial computer for purposes of reply communications. During both outbound and return communications in accordance with the relay protocol described in below greater detail, relay-related packets, whether original or modified, travel along hops 308 and 310 and are indicated by dashed lines. As will be appreciated, relay-related packets for outbound and return communications along hop 312 are devoid of routing information. However, the artisan will recognize that those packets transmitted along hop 312 are nonetheless derived from data requests from the launch computer and data replies from the target computer and would not be present otherwise. Furthermore, while FIG. 11a identifies 308 as “hop 1”, 310 as “hop 2” and 312 “hop 3”, these numerical designations correlate to the ordering of hops for outbound relay traffic, which order would be reversed in FIG. 11a for return relay traffic. FIG. 11b is similar to FIG. 11a except, here, only a single relay computer 305 is employed in the network.

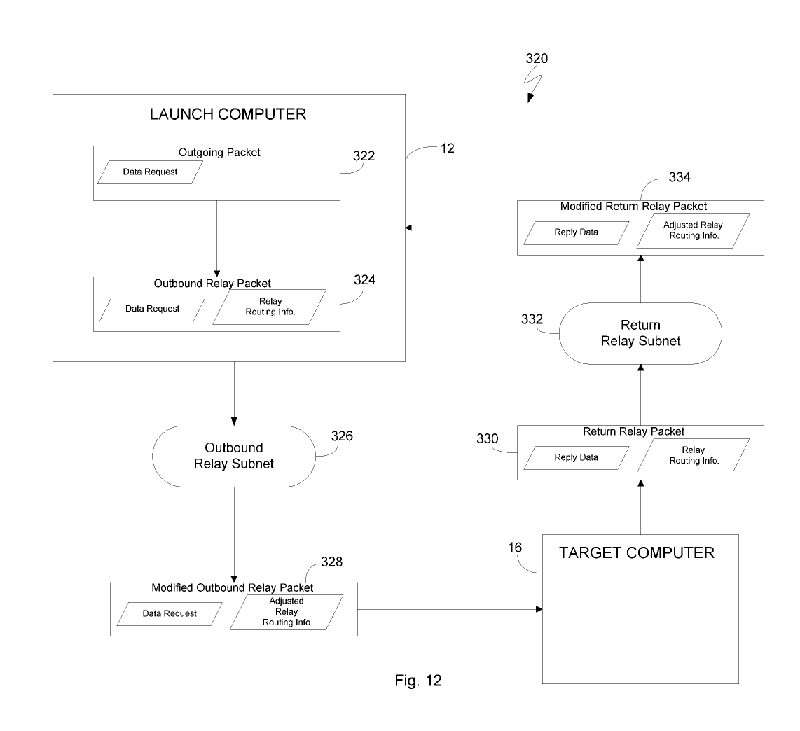

In the relay system of the present invention, it is preferred that the relay subnet send the outbound relay packets to the target computer in a manner which does not reveal the launch computer as the originator of the outbound packets. Instead, in the preferred embodiments, the target computer is lead to believe that the terminal outbound relay computer is the actual source of the outbound relay packets. With respect to return relay packets sent from the target computer to an initial return relay computer, such as relay computer 306 in FIG. 11a, these arrive at the launch computer with an indication that they are from the target computer, as opposed to the terminal return relay computer. Reference is made initially to the packet transition diagram 320 in FIG. 12 to introduce these capabilities. During outbound transmissions, launch computer 12 converts an outgoing packet 322 having the data request into an outbound relay packet 324 which incorporates outbound relay routing information. This conversion is accomplished by the launch computer's relay launch module which intercepts the packet as it proceeds down the network stack. The outbound relay packet 324 is then sent to the outbound relay subnet 326 and emerges as a modified outbound relay packet 328 having altered (in this case, removed) outbound routing information. Instead, the source data field for the emerging packet refers to the terminal outbound relay computer. As such, when the modified outbound relay packet 328 arrives at the target computer, it does so in a manner which does not reveal the identity of the launch computer as the packet's origin.

Target computer 16 thereafter transmits a return relay packet 330 to the return relay subnet 332. Return relay packet 330 incorporates the reply data which was gathered by the LKM installed on the target computer 16. More particularly, in the situation of a relay network configured as shown in FIG. 10a, target computer 16 transmits the return relay packet 330 to an initial return relay computer which is physically the same as the terminal outbound relay computer. A modified return relay packet 334 emerges from the return relay subnet 332. This packet is considered to be modified in the sense that various ones of its data fields were necessarily altered in route in order for it to ultimately arrive at the launch computer 12. As modified return relay packet 334 reaches the target computer it is intercepted by the target computer's relay module as it passes up the network protocol stack, as described in below figures, in order to adjust the routing information such that the target computer 12 is identified as the source of the packet instead of the terminal return relay computer. As such, the launch computer recognizes it as the reply to its earlier outbound transmission.

It is preferred in the various embodiments that the launch computer be the only one which is witting of the entire operation. The launch computer runs the software which packages and unpackages relay packets. The software is configured via a configuration file which determines if the packet is destined to a computer on the outbound relay list. The configuration file also lays out the outbound relay route that the packet will take. An example configuration file might include:

192.168.0.4:0=192.168.0.3:0+192.168.0.2:0+192.168.0.4:0

192.168.0.14:0=192.168.0.13:0+192.168.0.14:0

This tells the computer to send all packets addressed to 192.168.0.4 through the relay network via 192.168.0.3 then 192.168.0.2. It also instructs the launch computer to transmit packets destined to 192.168.0.14 through the relay network via 192.168.0.13. These IP addresses are, of course, for illustrative purposes only.

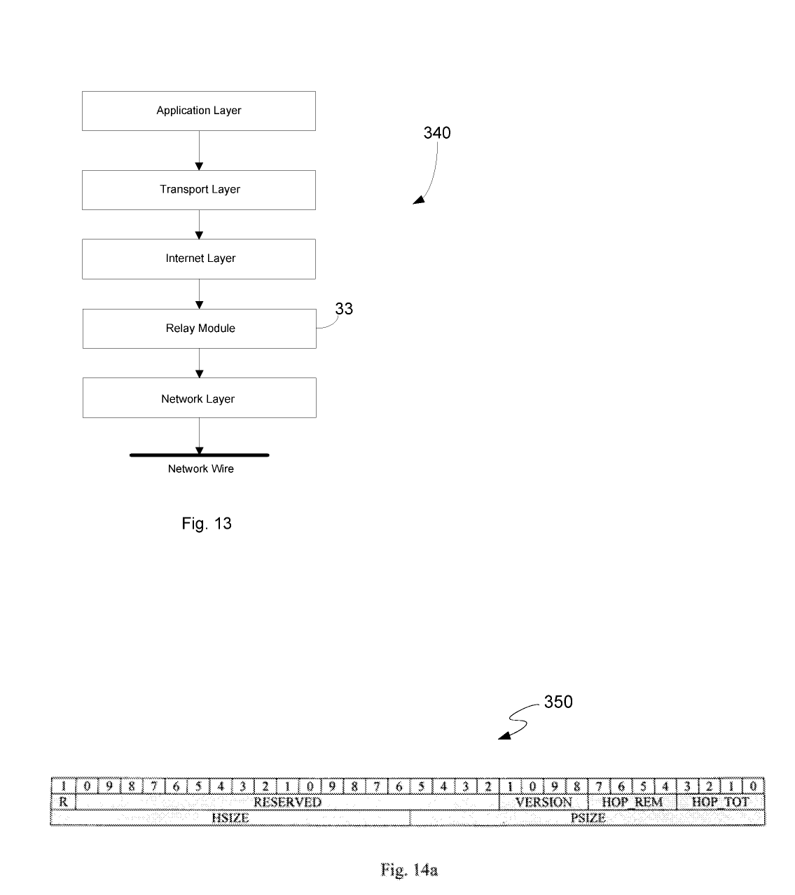

As a user connects to other machines the relay system examines the outgoing packets and, if the destination is on the relay list, the packet is altered to fit the relay specifications as described below. The relay launch module for accomplishing this may be inserted into the launch computer's OS, and in the case of a Unix implementation, via the usual insmod utility. The kernel module uses the Netfilter functionality to insert itself into the TCP/IP protocol stack 340, as depicted by the relay launch module 33 in FIG. 13. As part of the kernel module's initial start up procedures, the configuration file is processed to identify which destination IP addresses the outbound relay packets will be sent, and the predetermined outbound relay route they will take. Once installed, packets sent to the selected IP addresses are wrapped prior to transmission to the outbound relay subnet.

For outgoing packets which are on the destination list, the kernel module hooks into the outgoing TCP/IP stack using the Netfilter driver, allowing the modification of the packets as they depart from and arrive at the launch computer. As each packet is being constructed by the OS kernel and placed into the transmit queue, it is examined by the relay module to determine if it needs to be wrapped according to the relay protocol. That is, in order to traverse the relay network, an outgoing packet must be altered to include the routing information, as represented in FIG. 12, which indicates how the individual packet will be routed through the relay network in order to ultimately arrive at the target computer. The ordinarily skilled artisan will appreciate that the outbound relay packet must go through several steps in order to be sent through the relay network. For example, it must be enlarged to accommodate a relay header which must be built and inserted into the packet. The packet must also be marked as a relay packet, and the IP header checksum be recalculated.

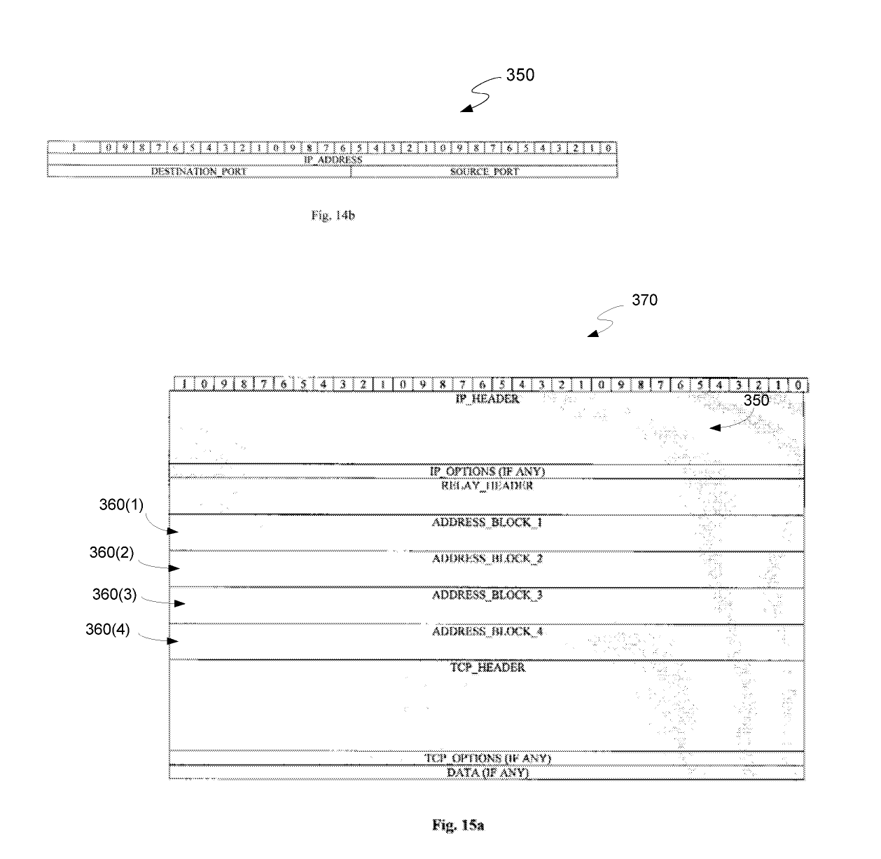

A representative relay header 350 is shown in FIG. 14a with it being understood that the least significant bit (LSB) is rightmost and the most significant bit (MSB) is leftmost. The relay header 350 is inserted into an outgoing packet and contains all of the information which the relay nodes need to route the outbound packets through the outbound relay subnet. The various fields for the relay header 350 are explained below:

Header Portion

R: return bit (0=forward path, 1=return path)

VERSION: relay version

HOP_REM: hops remaining in relaying

HOP_TOT: hops total in route

PSIZE: this relay header's size

HSIZE: this relay header's size+the address data following it

Address Block(s) Portion

IP_ADDRESS: the IP address for this hop

SOURCE_PORT: the source port of this hop

DESTINATION_PORT: the destination port of this hop

Since hop_tot is the total number of hops the packet will take, this allows the packets to take a different number of hops between the launch and target systems. The hop_rem is decremented as the packet travels from node to node. The version field is provided to allow the software to be used later for compatibility issues. In the current implementation, the reserved flags are not being used. FIG. 14b represents a single address block portion 360 for a relay header. Each address structure 360, as shown, includes an IP Internet protocol address field, a destination port field and a source port field.

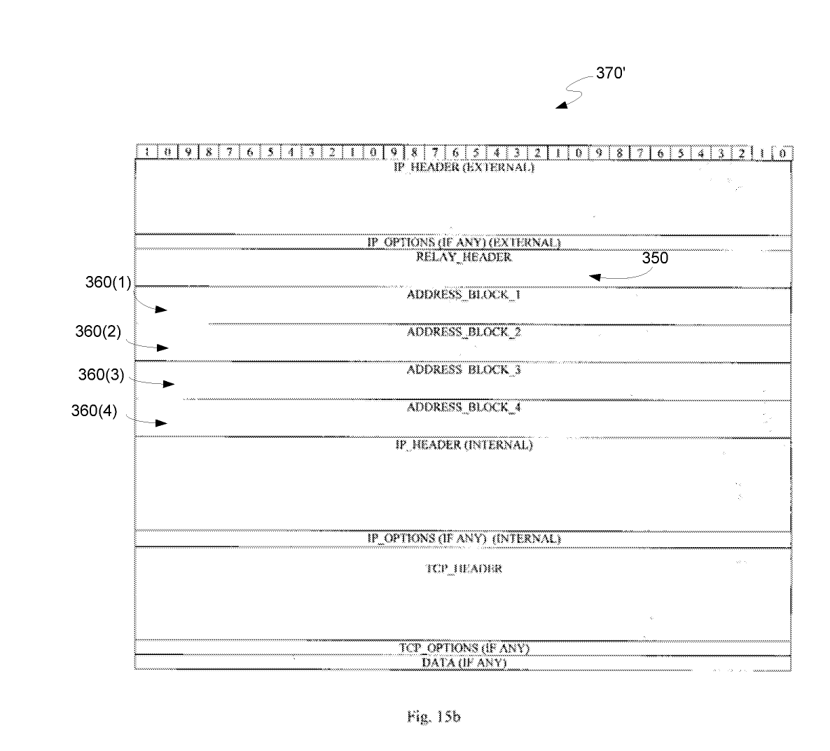

Two approaches have been contemplated for marrying a relay header and its one or more address blocks into an IP datagram. One approach is shown in FIG. 15a which depicts an encapsulated relay packet 370. This version “injects” the relay header 350 in the original outgoing packet immediately before the TCP header and following the IP header (or IP header options, if any). Some modification of certain parts of the IP header are needed in this version to accurately identify it as part of the relay protocol, for example, by setting the IP protocol field to “5”. A second encapsulated packet version 370′ is depicted in FIG. 15b. This version leaves the original outgoing packet data entirely intact; instead, it appends a new, external IP header, the relay header 350 and the address blocks 360(1)-360(4) at the beginning of the packet.

Currently, the relay module is adapted for use on computers running the Solaris and Linux operating systems. It will particularly work on Solaris 7, Solaris 8, Solaris 9, Linux 2.4.x and 2.6.x kernel series. To insert the header into an outgoing packet, the skb_copy_expand (<linux/skbuff.h>) function call can be used which copies the original packet over and introduces the requested extra space. Once the correct packet size is created, the information is copied over. The relay header is copied into the buffer. The IP header checksum is calculated using the updated information. Once this is completed, the packet is placed, the original packet is deleted, and the new packet is inserted into the transmit queue. This will send the relay packet to the initial outbound relay computer on the outbound relay subnet.

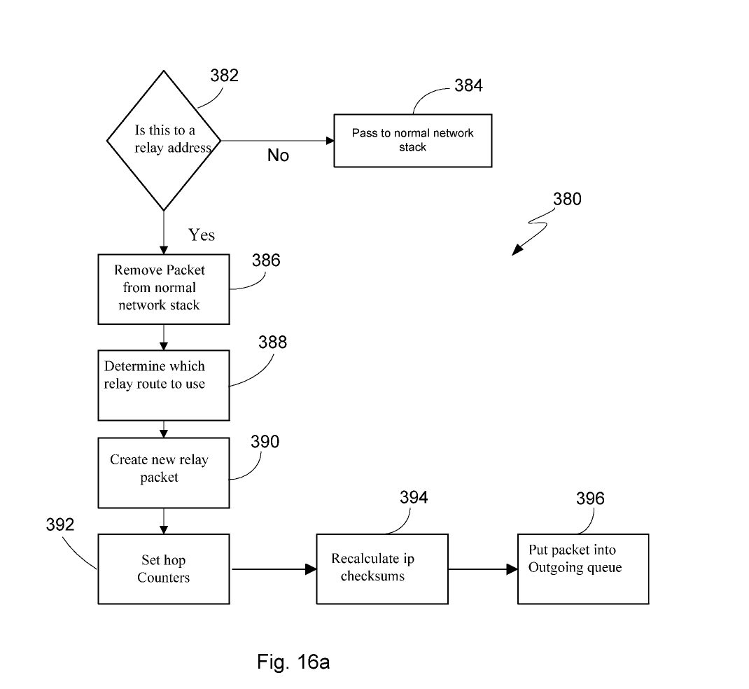

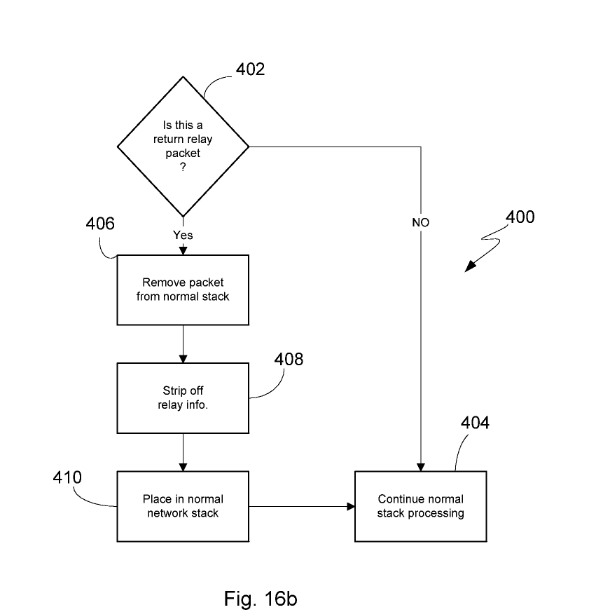

A decision-making flowchart for the outbound protocol stack of the launch computer is shown as 380 in FIG. 16a. A determination is made at 382 as whether the outgoing packet is destined for a relay address within the configuration files relay list. If not, the outgoing packet is allowed to pass to the normal network stack at 384. Otherwise, the outgoing packet is intercepted and removed from the normal network stack at 386 and a determination is made at 388 as to which relay route to use. It is, thus, contemplated that the configuration file may store a plurality of outbound relay routes given that a plurality of target computers might be of interest. Once the particular outbound relay route is ascertained, a new relay packet is created at 390 and the hop counters are set at 392 to the number of relay nodes to be used. This enables each relay node to determine if it is an end relay node. IP checksums are recalculated at 394 and the relay packet is then placed into the outgoing queue of the network stack at 396.

The launch computer also has the responsibility of examining all incoming packets to ascertain whether they are, in fact, return relay packets. Once identification of a return relay packet is made, the launch computers kernel module will preprocess the packet before sending it up the TCP/IP network stack. The reason for the alteration of the packet is that the process which is expecting a return packet, expects the return packet to be from the target computer's IP, not the IP of the terminal return relay computer. Thus, the return relay packet's source IP is changed to be that of the target computer's IP address. The data in the return relay packet is copied up over the relay header to remove the relay header from the packet. The IP length is modified to correct the length and the header checksum is recalculated. Then, the packet is allowed to continue up the protocol stack according to normal IP functions. This allows the launch computer's applications to be unaware that they are utilizing the relay network. Thus, any application using TCP can seamlessly use the relay network with no extra configuration required on a per application basis.

Accordingly, FIG. 16b shows the decision-making 400 which takes place for incoming packets on the launch computer. If a determination is made at 402 that the incoming packet is not a return relay packet, then it is passed at 404 to the normal network stack for continued processing. However, if the incoming packet is a return relay packet, it is intercepted and removed from the normal network stack at 406 and has its relay information stripped off at 408. Thereafter, the incoming packet (i.e., the return relay packet) is placed back in the network stack at 41 0 for further processing at 404.

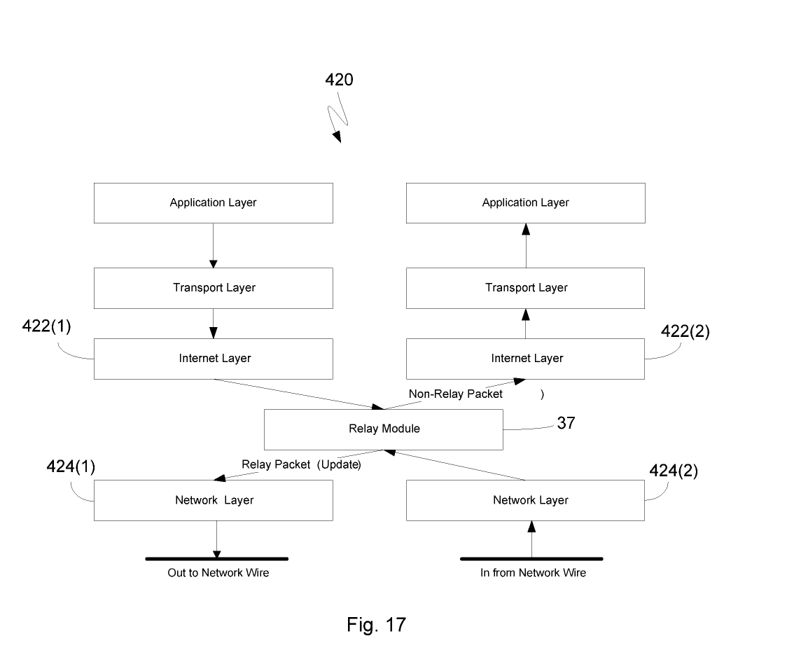

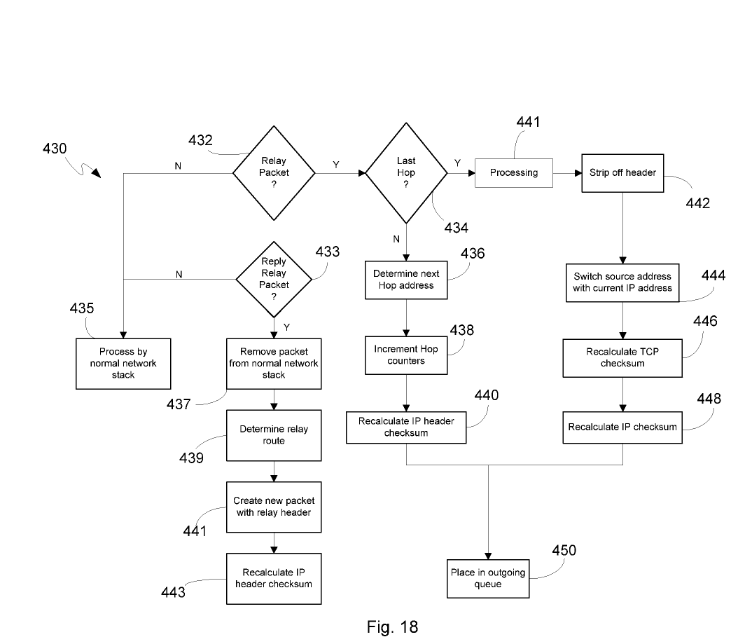

Reference is now made to FIGS. 17 and 18 to describe what transpires at the relay computers. The various relay computers may have the same software installed, although initial and terminal relay computers within the relay subnets function differently than others. A global relay module, however, can be configured to allow a given relay computer to function in either mode. When a relay computer is functioning purely as a relay (i.e., not an end node) it takes inbound relay packets and forwards them to the next relay node. However, when it is functioning as an end point, the node must deal with wrapping and unwrapping of the packets.

The relay module may be inserted into the network stack by the dev_add_pack (<linux/netdevice.h>) function. This allows the module to examine every packet before it is passed up the remainder of the stack, and insert packets into the stack. The module can then intercept packets from the stack and pull them off so that the normal network stack does not examine them. This prevents any other application, such as sniffers on the relay computer, from seeing the relay packets.

Each packet arriving at a relay computer/node is examined. If the packet is marked as a relay packet, for example, by having its IP [protocol] field designated in a manner which does not adhere to typical packets, then it is removed from the stack and processed by the relay module. The relay module examines the packet's relay header to determine if it is the last relay module, as well as what direction the relay packet is traveling. By checking the number of total hops versus hops taken, a decision is made as to whether this is the final hop along the route. When the packet is to be forwarded to another relay computer, the relay module increments the number of hops taken, looks in the relay header for the entry containing the information for the next hop, and retrieves the address of the next relay node. The relay module updates the addresses of the relay packet, as well as the IP header checksum. The new packet is then placed into the transmit queue and sent to the next node in the relay network.

FIG. 17 illustrates the interaction of the relay module with the outbound and inbound network stacks of a relay computer which is not an end node. Relay module 37 hooks into the network stack between outbound Internet layer 422(1) and network layer 424(1), and between inbound Internet layer 422(2) and network layer 424(2).

As can be seen in FIG. 17, inbound packets from the network layer 424(2) are intercepted by relay module 37. Those packets which are not relay packets are sent up the stack to Internet layer 422(2). However, if they are relay packets they are diverted and redirected back to the network layer 424(1) of the outbound stack. Suitable relay routing information is updated during this time. Outgoing packets proceeding down the network stack from Internet layer 422(1) may be inspected by the relay module 37, but will simply continue down the outbound stack to the network layer 424(1) without modification.

The launch computer and the terminal outbound relay computer are each responsible for unwrapping the packet according to the relay protocol. In addition, where the terminal outbound relay computer is also the initial return relay node it has the further responsibility of wrapping and forwarding each reply packet from the target computer. It must also keep track of packets which are sent out since the reply packets from the target computer will not have relay header information embedded in them.

With reference to the decision-making flowchart 430 in FIG. 18, the terminal relay computer scans incoming packets at 432 to ascertain if they are marked as relay packets. If the packet is a relay packet it is taken from the normal TCP/IP stack, preventing its detection by the host OS. The next step 434 determines whether this is the last hop in the relay subnet. If not, the next hop address is determined at 436, the hop counters are incremented at 438 and the IP checksum is recalculated at 440 before the packet is placed into the outgoing queue at 450.

If, however, this is the last hop, corresponding to the relay computer being a terminal outbound relay computer, then the relay module performs some additional processing on the packet at 441. Initially, the packet is examined to determine if it is a SYN packet since TCP packets are sent with the SYN flag set to start the standard three-way handshake that most protocols use to initiate connections. If the packet is a SYN packet, the relay module logs the connection to a linked list. The packet's destination IP address, port number and sequence number are logged, as well as the relay header. The relay header is kept so that response packets can be sent back to the originating computer. The relay header's addresses are preferably copied in reverse order so that all reply relay packets can just copy the header without needing to rearrange the packets. The linked list is searched to ensure there is not already an entry for the connection, which would be the case if there are matching sequence numbers and IP addresses. This needs to occur since most applications will send multiple SYN packets if no response is received. Once the connection information has been added to the linked list the packets must be corrected to be sent to the target computer.

After stripping off the header at 442, the packet's source address is switched to be the current IP address. Preferably, this is accomplished by initially copying the IP destination address into the IP source address field. Then, the original destination address is copied into the IP destination address. This will properly address the packet, since the original source address was that of the launch machine. Then, the packet's data that follows the relay header is moved over the relay header. The packet is then set to the correct length and the TCP and IP checksums are recalculated at 446 and 448, respectively. Finally, by use of the ip_route_me_harder( ) (<linux/netfilter_ipv4.h>) and arp_find( ) (<net/arp.h>) functional calls, the MAC addresses for the destination computers are found. These are copied into the Ethernet header fields. Finally, the packet is placed into the outgoing queue at 450 with the dev_queue_xmit() (<linux/netdevice.h>) function, which sends the packet to the target computer.

Another function of a terminal outbound relay computer is to properly send reply relay packets back through the relay subnet to the launch computer. The terminal node inspects each incoming packet at 433 to determine if it is a reply packet. This is accomplished by checking the source port field of the TCP header with the destination port in the linked list. A proper reply packet's source port will match to the initiating packet's destination port. If there is no match, the packet is simply allowed at 435 to be processed further up the network stack according to normal OS procedures. However, if there is a match, the packet must be sent through the relay subnet back to the launch computer. The packet is removed from the network stack at 437 and a determination is made at 439 as to which relay route to use. The packet is copied and the size expanded using the skb_copy_expand (<linux/netdevice.h>) call. Once a new packet is created with the appropriate space allocated, the IP header information is copied over from the old packet to the new packet. However, the end node's IP address is placed in the source address field so that the packet can be properly routed. Then, the relay header is copied into the packet, enabling the relay network to properly route the packet. After that, the proper MAC addresses are placed in the packet, which are determined as discussed above. At this point 441, a new packet has been created with the appropriate relay header. Finally, the IP header checksum is recalculated at 443 and the packet is placed in the outgoing queue at 450. It can be appreciated from the above that a terminal outbound relay computer has the responsibility of much more processing than other relay computers, yet its operating system is still unwitting of the relay-related traffic.

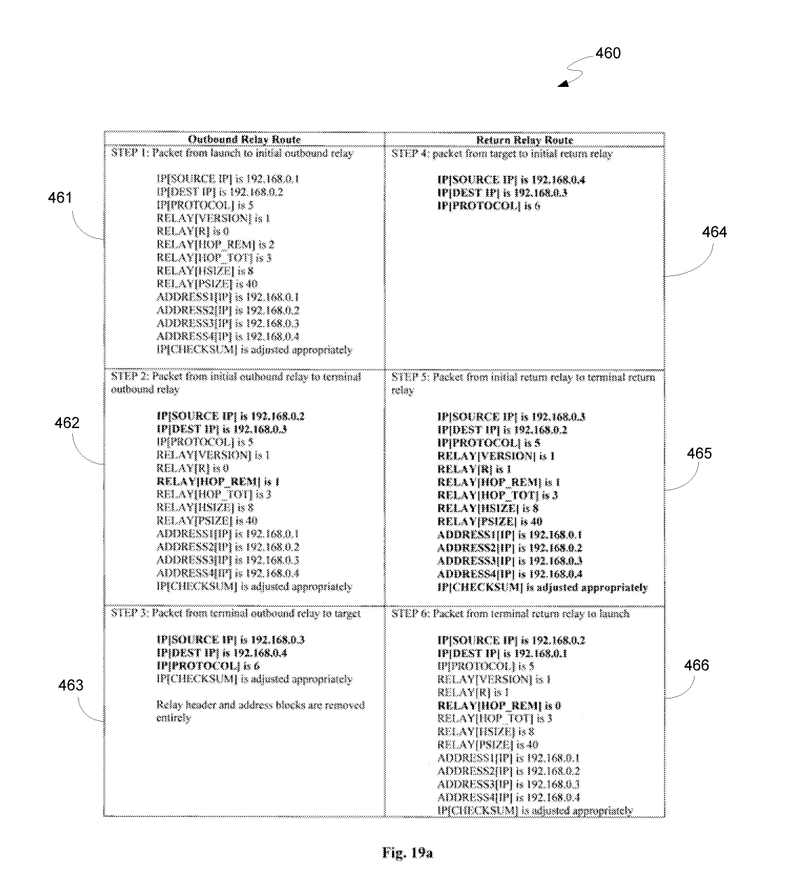

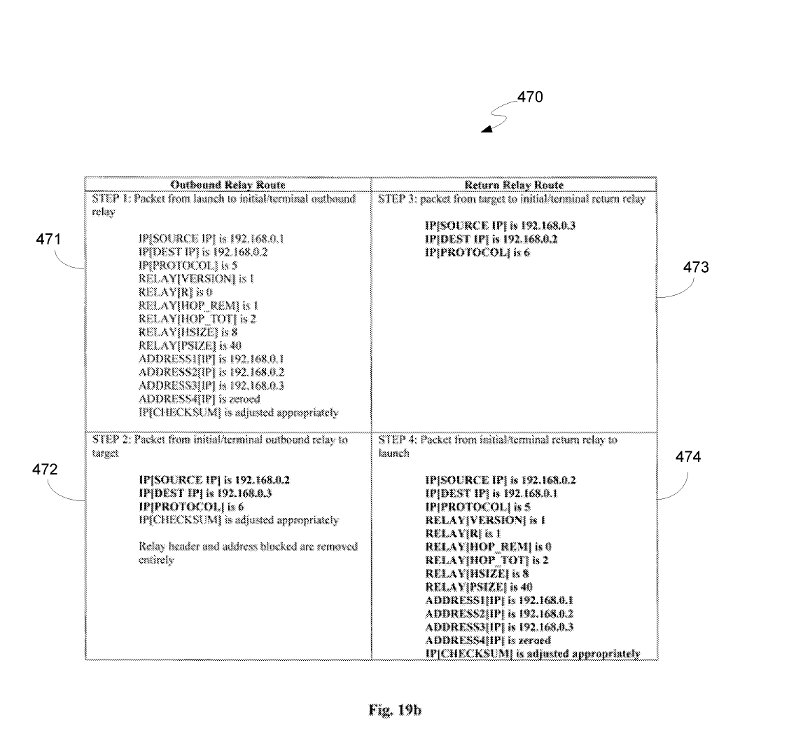

With an appreciation of the above description of the relay portion of the present invention, reference is now made to FIGS. 19a and 19b which illustrate in tabulated form packet state diagrams 460 and 470 for two representative relay networks such as those in FIGS. 11a and 11b above. In each of these packet state diagrams the left column relates to outbound relay-related packets from the launch computer toward the target computer, and the right column relates to return relay-related packets from the target computer toward the launch computer. Each row relates to a respective hop along a relay route. So, for example, steps 461-463 in FIG. 19a correspond to hops 1 to 3 in FIG. 11a, and steps 464-466 in FIG. 19a correspond to hops 3 to 1 in FIG. 19a. A similar interpretation follows for FIG. 19b as it relates back to FIG. 11b. In each of FIGS. 19a and 19b, the various fields for the relay headers are shown for each stage along either the outbound or return relay routes, with those fields whose data values have been changed relative to the preceding field being indicated in the figures by bold typeface for ease of understanding.

In FIG. 19a, four total computers are involved, again having representative addresses:

ADDRESS_BLOCK_{—}1=launch computer

ADDRESS_BLOCK_{—}2=1^{st} relay computer

ADDRESS_BLOCK_{—}3=2^{nd} relay computer

ADDRESS_BLOCK_{—}4=target computer

With initial reference to the outbound relay route column comprising steps 461-463, it is seen in step 461 that the relay header, among other things, reflects all of the IP addresses for the computers within the outbound relay subnet. Since these are relay packets, the IP [protocol] field is designated by a suitable number, such as numeral 5, so that the operating systems on the various computers which see this designation will recognize such packets as relay-related packets. For non-relay related traffic, the packets would have a different IP [protocol] field destination such as the number 6. It may also be seen in the packets of steps 462 and 463 that they can be identified as outbound packets by the relay [R] flag “0”, while the packets for steps 465 and 466 have their relay flags set to “1”. Another field worth mention is the hop_rem field which is adjusted accordingly as the packets travel through the relay subnets. With specific reference to the packets corresponding to steps 463 and 464 it can be seen that, since these packets are encountered by the target computer, they do not contain information corresponding to the actual route taken. This effectively hides from the target computer's OS, and presumably its user(s), the fact that it is involved in a relay system.

Finally, the packet state diagram 470 of FIG. 19b has only two steps 471 and 472 involved in the outbound relay route, and two steps 473 and 474 involved in the return relay route since this contemplates only a single relay computer involved in the communications. Similar interpretations for the various relay header fields of the packets for states 471-474 apply as with FIG. 19a so that they need not be discussed in further detail.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A system, comprising:
a. first and second network communications devices adapted to communicate with one another according to a layered communications protocol that is characterized by a protocol stack, said first network communications device for issuing a data request to said second network communications device along a predetermined first relay route therebetween, and said second network communications device for transmitting a reply to said data request along a predetermined second relay route therebetween; and
b. a relay subnet defining the predetermined first relay route and the predetermined second relay route, said relay subnet including at least one intermediary network communications device adapted to communicate according to said layered communications protocol that is characterized by an associated intermediary device protocol stack and configured to forward:
(i) outbound traffic corresponding to said data request to the second network communications device without revealing the first network communications device as an origin of said data request; and
(ii) inbound traffic corresponding to said reply toward said first network communications device.

2. A system according to claim 1 wherein said data request is transmitted within an outbound relay packet, and wherein said reply is transmitted within a reply relay packet.

3. A system according to claim 1 wherein said outbound traffic, upon arrival at the second network communications device, identifies said intermediary network communications device as an origin of said data request.

4. A system according to claim 1 wherein traffic arriving at said intermediary network communications device which is derived from data request is forwarded without being passed entirely up the intermediary device's protocol stack.

5. A command and control system, comprising
a. a launch computer having installed thereon a launch tool set configured to issue data requests;
b. a target computer having installed thereon a target tool set configured to respond to said data requests with data replies; and
c. at least one relay computer having installed thereon a relay tool set configured:
(i) to forward data requests from the launch computer to the target computer, while not identifying the target computer to the launch computer as an origin of said data requests; and
(ii) to forward said data replies from the target computer toward the launch computer.

6. A command and control system, comprising:
a. a launch computer adapted to communicate according to a layered communications protocol that is characterized by a launch computer protocol stack;
b. a target computer adapted to communicate according to said layered communications protocol that is characterized by an associated target computer protocol stack;
c. a front end trigger component issuing data requests to the target computer;
d. a response component replying to said data requests with data replies; and
e. a data transmission component which:
(i) transmits said data requests from the launch computer to the target computer via a predetermined outbound relay route, while concealing an identity of the launch computer from the target computer; and
(ii) transmits said data replies from the target computer to the launch computer via a predetermined reply relay route.

7. A command and control system according to claim 6 wherein said front end trigger component resides on the launch computer and includes a command and control console for generating trigger commands corresponding to said data requests.

8. A command and control system according to claim 7 wherein said trigger commands are transmitted to the target computer according to the user datagram protocol (UDP).

9. A command and control system according to claim 6 wherein each of said launch and target computers includes an associated Telnet server for establishing connections therebetween.

10. A command and control system according to claim 6 wherein each of said launch and target computers includes an associated stream server to permit encrypted transmissions therebetween.

11. A command and control system according to claim 10 wherein said encrypted transmissions are in accordance with the transmission control protocol (TCP).

12. A command and control system according to claim 10 wherein each of said launch and target computers stores a unique key used for encrypting the transmissions therebetween.

13. A command and control system according to claim 6 wherein said data transmission component comprises an outbound relay subnet including at least one outbound relay computer for forwarding data requests originating from the launch computer toward the target computer, and a return relay subnet including at least one return relay computer for forwarding data replies originating from the target computer toward the launch computer.

14. A command and control system according to claim 13 wherein said outbound relay computer and said return relay computer are the same.

15. A command and control system according to claim 13 wherein said outbound relay subnet includes a plurality of outbound relay computers and said return relay subnet includes a plurality of return relay computers.

16. A network communications device configured for use as a participant in a command and control system, said device comprising:
a. a memory storing an operating system which allows the network communications device to communicate with other computers on a relay network according to a layered communications protocol that is characterized by a protocol stack, wherein said relay network comprises an outbound relay subnet and a return relay subnet;
b. a storage device storing a tool set for issuing data requests to a target computer via the outbound relay network;
c. an input/output system which includes a network adapter for interfacing the network communications device to the relay network; and
d. a processor that is programmed:
(i) with respect to each outgoing packet which corresponds to a data request destined for the target computer, to incorporate into the outgoing packet associated outbound routing information, prior to continued processing by the protocol stack;
(ii) with respect to each outgoing packet that is not destined for said target computer, to allow said outgoing packet to be processed by the protocol stack without modification;
(iii) with respect to each inbound packet arriving from a relay computer along the return relay subnet, to convert the respective inbound packet into one which corresponds to a reply transmission from the target computer prior to continued processing by the protocol stack; and
(iv) with respect to each inbound packet arriving from a non-relay computer along the return relay subnet, to allow the respective inbound packet to be processed by the protocol stack without modification.

17. A network communications device according to claim 16 wherein said layered communications protocol is TCP/IP.

18. A network communications device according to claim 16 wherein said tool set includes a front end trigger component for generating trigger commands corresponding to said data requests.

19. A network communications device according to claim 16 including a Telnet server for establishing connections to the computers on the relay network.

20. A network communications device according to claim 16 including a stream server to permit encrypted transmission between the network communications device and the computers on the relay network.

21. A network communications device according to claim 16 wherein said storage device stores a key file having a unique key used for encrypting transmissions to the computers on the relay network.

22. A method of remotely accessing and controlling a target computer from a launch computer, comprising:
a. installing a set of launch tools on the launch computer;
b. obtaining system level access to the target computer;
c. uploading a set of target tools to the target computer, wherein said target tools include a loadable kernel module (LKM) responsible for retrieving reply data from the target computer in response to a data request issued from the launch computer;
d. installing said LKM on the target computer;
e. logging off the target computer;
f. sending an outbound relay packet containing said data request along a predetermined outbound relay route from the launch computer to the target computer; and
g. receiving from the target computer a reply relay packet in response to said outbound transmission packet, wherein said reply relay packet is one which traveled along a predetermined return relay route from the target computer to the launch computer.

23. A method according to claim 22 wherein each of the set of launch tools and the set of target tools includes an associated Telnet server for establishing connections between the launch and target computers.

24. A method according to claim 23 comprising sending said outbound packet according to the user datagram protocol (UDP).

25. A method according to claim any one of claims 22 and 23 wherein each of the set of launch tools and the set of target tools includes an associated stream server for permitting encrypted packet transmissions between the launch computer and the target computer.

26. A method according to claim 25 wherein each of the set of launch tools and the set of target tools includes an associated key file which stores a unique key used for encrypting said transmissions.

27. A method according to claim 25 comprising encrypting said outbound packet before it is sent toward the launch computer, and encrypting said reply packet before sending it toward the launch computer.

28. A method according to claim 22 whereby said LKM is installed in a location on the target computer which is unlikely to be accessed by an authorized user of the target computer.

29. A method according to claim 28 wherein said location is a hard disk associated with the target system.
